(19) United States
(12) Patent Application Publication
(10) Pub. No.: US 2010/0310749 A1
(43) Pub. Date: Dec. 9, 2010

(54) MOISTURE-RETAINING BAKED GOODS

(76) Inventors: Jessica Cristadoro, Naperville, IL (US); Adam Hegadorn, Bartlett, IL (US); David Meza, Cicero, IL (US)

Correspondence Address: FOLEY & LARDNER LLP, 150 EAST GILMAN STREET, P.O. BOX 1497, MADISON, WI, 53701-1497, US

(21) Appl. No.: 12/481,055

(22) Filed: Jun. 9, 2009

(51) Int. Cl. A23L 1/05; A21D 13/08; A21D 10/04; A23L 1/30; A21D 13/00; A23L 3/36

(52) U.S. Cl. 426/553; 426/575; 426/648; 426/496; 426/389

(57) ABSTRACT

Batters are described having gellan gum and other components. The gellan gum is present in an amount effective to provide a baked good formed from the batter having a retained moisture content ranging from about 25% to about 40%. The baked goods and methods for making the baked goods are also disclosed.

### FIELD OF THE INVENTION

The present invention generally relates to baked goods. In particular, batters are disclosed that are capable of providing baked goods exhibiting moisture retention.

### BACKGROUND

Baked goods such as cakes, muffins, brownies, biscuits, and scones are popular food items. However, these baked goods typically have a short-shelf life due to moisture migration and desiccation. Moisture migrates from an area of the baked good having a high moisture content to an area with reduced moisture, such as the atmosphere, or to an area of the baked good having a low moisture content, such as glaze or icing on the baked good. Moisture migration results in a dried baked good having an unpleasant appearance, texture, mouthfeel, and flavor.

### SUMMARY

In one aspect, a batter is provided for making a baked good. In particular, batters are provided which are capable of producing baked goods having a high retained moisture content, improved moisture retention, extended shelf-life, and high perceived moisture.

The batters include gellan gum. It has been found that not all gum components are equivalent. Xanthan gum thickens batters during the mixing process. Such thickening may result in the batter becoming extremely thick and unworkable. However, it has been found that replacing xanthan gum with gellan gum provides thinner batters during the mixing process. Moreover, baked goods formed from gellan gum-based batters exhibit reduced shrinkage. Sodium alginate and monoglyceride emulsifiers may also be included in the batter. It has been found that it is possible to add a much greater amount of moisture to batters containing sodium alginate, a monoglyceride emulsifier, and gellan gum at specific amounts, thereby reducing the cost of the batter and achieving a baked good having a higher retained moisture content, moisture retention, and longer shelf-life than conventional baked goods formed from conventional baking methods.

The amounts of gellan gum, sodium alginate, and/or monoglyceride emulsifiers in the batter may vary. In some embodiments, the amount of these ingredients present in the batters is that amount which is effective to provide a baked good having a retained moisture content ranging from about 25% to about 40%. However, other amounts and other retained moisture contents are possible.

The batter may include a variety of other components present in varying amounts. Non-limiting examples of other components include flour, a leavening system, fat, a protein supplement, and a humectant, although other components are possible. Specific examples of each of these components are provided herein.

The batters may be used to form a variety of baked goods. Specific examples of baked goods are provided herein. In some embodiments, the baked good is a cake.

In another aspect, methods of making baked goods from the disclosed batters are provided. The methods may include forming any of the batters described herein and baking the batter to provide the baked good. Techniques for baking the batters are described herein. The methods may further include a variety of other steps, including, but not limited to cooling the baked good, depanning the baked good, assembling the baked good, and freezing the baked good.

### DETAILED DESCRIPTION

Unless otherwise stated, amounts of components are given in weight percent, based on the calculated total weight of all added components.

In one aspect, the batters include sodium alginate. Sodium alginate is the sodium salt of alginic acid. Sodium alginate adds viscosity to the batter and is capable of binding water. Sodium alginate is commercially available from a number of sources including, but not limited to, Gum Technology of Tucson, Ariz., and sold under the trade names of Coyote Brand Algin SA-HV, and Coyote Brand Algin SA; FMC BioPolymer of Philadelphia, Pa., and sold under the trade names Protanal LFR 5/60, Protanal LF 240 D, Protanal LF 120 M, Protanal LF 200 M, Protanal LF 10/60, Protanal LF 10/60 LS, Protanal HF 120, Protanal HF 120 RBS, Protanal LF 200 DL, and Protanal LF 200 S; Danisco Copenhagen, Denmark and sold under the trade name Grinsted Alginate FD 100, FD 120, FD 122, FD 125, FD 127, FD 150, FD 155, FD 157, FD 170, and FD 175; and Tic Gums of White Marsh, Md. and sold under the trade name TICA-Algin 400F, Algin 900F, Algin HG-300, Algin HG-400, and Algin HG 600F. The sodium alginate is present in an amount effective to provide a baked good formed from the batter having any of the retained moisture contents discussed below. In some embodiments, the sodium alginate is present in an amount that ranges from about 0.1% to about 4%. This includes, but is not limited to, amounts of sodium alginate of about 0.2%, about 0.5%, about 0.8%, about 1%, about 2%, and about 3%. In other embodiments, the sodium alginate is present in an amount that ranges from about 0.1% to about 1%. In still other embodiments, the sodium alginate is present in an amount that ranges from about 1.5% to about 3%.

In some embodiments, the batters also include a monoglyceride emulsifier. The monoglyceride emulsifier component softens crumb structure without aerating the batter. A variety of sources of monoglyceride emulsifiers may be used. By way of example only, any of the monoglyceride formulations produced by Caravan Ingredients of Lenexa, Kans. may be used, including, but not limited to BFP 800, Starplex 90, Alphadim 2 HS, Alphadim 70 K, Alphadim 90 SBK, Alphadim 90 SBK FG, and Alphadim DBK. Similarly, any of the monoglyceride formulations produced by Kerry Biosciences of Norwich, N.Y. may be used, including, but not limited to Myverol P-06 K, Myverol P-08 K, Myverol 18-06 K, and Myverol 18-04 K. In some embodiments, the monoglyceride emulsifier is a distilled monoglyceride emulsifier. In addition, any of the monoglyceride formulations produced by Danisco of Copenhagen, Denmark and sold under the trade names DIMODAN HP, DIMODAN P PEL/B, and DIMODAN PH 100 NS/B may be used. The monoglyceride emulsifier is present in an amount effective to provide a baked good formed from the batter having any of the retained moisture contents discussed below. In some embodiments, the monoglyceride emulsifier is present in an amount that ranges from about 0.1% to about 6%. This includes, but is not limited to, amounts of monoglyceride emulsifier of about 0.2%, about 0.5%, about 0.8%, about 1.5%, about 2%, about 3%, about 4%, and about 5%. In other embodiments, the monoglyceride emulsifier is present in an amount that ranges from about 0.1% to about 2%. In still other embodiments, the monoglyceride emulsifier is present in an amount that ranges from about 2% to about 4%.

In other embodiments, the batters also include a gellan gum. The gellan gum component provides thinner batters and baked goods having reduced shrinkage. Gellan gum from a variety of sources may be used. By way of example only, any of the gellan gum formulations produced by China Gelling, Zhejiang, China may be used, including, but not limited to Gellan Gum. Similarly, any of the gellan gum formulations produced by CP Kelco of Atlanta, Georgia may be used, including, but not limited to Kelcogel and Kelcogel F. The gellan gum is present in an amount effective to provide a baked good formed from the batter having any of the retained moisture contents discussed below. In some embodiments, the gellan gum is present in an amount that ranges from about 0.01% to about 5%. This includes, but is not limited to, amounts of gellan gum of about 0.02%, about 0.05%, about 0.08%, about 0.5%, about 1%, about 2%, about 3%, and about 4%. In other embodiments, the gellan gum is present in an amount that ranges from about 0.05% to about 2%. In still other embodiments, the gellan gum is present in an amount that ranges from about 2% to about 4%.

Compared to conventional baked goods, the baked goods formed from the disclosed batters have much greater retained moisture content, and thus, greater shelf-lives. By retained moisture content, it is meant, the amount of moisture present in the finished baked good, as opposed to the unbaked batter. The retained moisture content of the baked goods formed from the disclosed batters may range from about 25% to about 40%. This includes embodiments in which the retained moisture content ranges from about 27% to about 37%, or from about 30% to about 35%. Techniques for determining the retained moisture content of baked goods are known. Briefly, one such technique is a modified version of the Association of Official Analytical Chemists Official Method 934.06 Moisture in Dried Fruits. This method is a loss of drying, gravimetric method which uses a vacuum oven at 70° C., less than 100 mmHg for 5 hours.

The disclosed batters may include a variety of other components. By way of example only, the disclosed batters may include flour, a leavening system, fat, a protein supplement, a humectant, or combinations thereof. However, in some embodiments, the batter does not include xanthan gum.

Flour may be present in the batter to impart structure. Various amounts of flour may be present. In some embodiments, the amount ranges from about 2% to about 35%. In other embodiments, the amount ranges from about 2% to about 20%. This includes, but is not limited to, amounts of flour of about 5%, about 10%, about 15%, about 20%, about 25%, and about 30%. A variety of flours may be used, including, but not limited to soft wheat flour, hard red spring wheat flour, whole wheat flour, whole white wheat flour, corn flour, rice flour, oat flour, barley flour, soy flour, high amylose flour, low amylose flour, or combinations thereof. The flour can be treated or untreated. Such treatments include bleaching, malted flours, heat treatment, addition of oxidizing agents, maturing agents, or reducing agents, enrichment with vitamins and/or minerals, or combinations thereof.

A protein supplement may be present in the batter to provide structure, strength, and flexibility to the batter. Protein supplements can also aid in achieving the desired cake-like texture. Various amounts of protein supplement may be present. In some embodiments, the amount ranges from about 1% to about 4%. This includes, but is not limited to, amounts of protein supplements of about 1.5%, about 2%, about 2.5%, about 3%, and about 3.5%. Protein supplements may include egg proteins, dairy proteins, and wheat proteins (gluten in flour). Non-limiting examples of dairy proteins include caseinate, buttermilk, buttermilk solids, milk, nonfat dry milk, dried whole milk, instant nonfat dry milk, whey, milk protein concentrate, soy protein, and the like. Other suitable protein supplements can include amino acids such as cystine, serine, histidine, aspartic acid, lysine, arginine, glutamic acid, asparagine, glutamine, threonine, methionine, proline, tryptophan, turicine, glycine, leucine, alanine, isoleucine, valine, and phentolamine. Other such protein supplements may include actin, collagen, keratin, carboxypeptidase, trypsin, fibroin, sclerolin, myosin, and the like.

Humectants may present in the batter to provide sweetness, provide browning during the baking process, tenderize the batter, and to further retain moisture. Various amounts of the humectants may be added. In some embodiments, the amount ranges from about 1% to about 35%. This includes, but is not limited to, amounts of humectants of about 2%, about 5%, about 10%, about 15%, about 20%, and about 30%. Humectants may be sugar-based, non-sugar-based, or a combination thereof. Sugar-based humectants include, but are not limited to sucrose, glucose, fructose, dextrose, corn syrup, corn syrup solids, invert syrup, high fructose corn syrup, maltose, honey, sorbose, mannose, maltose, lactose, galactose, and combinations thereof. Non-sugar-based humectants include, but are not limited to glycerin, xylitol, propylene glycol, hydrogenated starch hydrolysates, sugar ester, dextrin, maltitol, mannitol, sorbitol, glycerol, and combinations thereof.

A leavening system may be present in the batter for aeration. Various amounts of the leavening system may be added. In some embodiments, the amount ranges from about 0.25 to about 2.5%. This includes, but is not limited to, amount of the leavening system of about 0.5%, about 1%, about 1.5%, and about 2%. The leavening system maybe a yeast leavening system. Alternatively, the leavening system may be a chemical leavening system. For example, the leavening system may consist of an acidic leavening agent and a basic leavening agent which react in the presence of water to produce carbon dioxide. The leavening system can be either single acting or double acting. Single acting leavening systems generally consist of heat activated acidic leavening agents. In this case, the acidic and basic leavening agents do not react until they are exposed to heat. On the other hand, double acting leavening systems consist of both a heat activated leavening acid and a leavening acid that instantly reacts with the basic leavening agent in the presence of water. A portion or all of either the basic or acidic leavening agents may be encapsulated.

Basic leavening agents that are useful in the disclosed batters include, but are not limited to sodium bicarbonate (baking soda), ammonium carbonate, potassium bicarbonate, ammonium bicarbonate, and combinations thereof.

Acidic leavening agents that are useful in the disclosed batters include, but are not limited to sodium aluminum phosphate, sodium acid pyrophosphate, monocalcium phosphate monohydrate, monocalcium phosphate anhydrous, dicalcium phosphate dihydrate, dicalcium phosphate, glucono-deltalactone, sodium aluminum sulfate, potassium hydrogen tartrate, and combinations thereof.

Fats may be present in the batter to provide a soft and tender texture and to improve flexibility. Forms of fats that are useful in the disclosed batters include, but are not limited to liquid oils, shortenings, shortening chips, margarines, and combinations thereof. The source of fat can be either animal, vegetable, or synthetic. Sources of fat may include soybean oil, coconut oil, palm kernel oil, cottonseed oil, peanut oil, olive oil, lard, butter, sucrose polyesters, sunflower seed oil, sesame seed oil, corn oil, safflower oil, poppy seed oil, canola (rapeseed) oil, babassue oil, or combinations thereof. Fats, when present, may be included in amounts ranging from about 5% to about 20%. This includes, but is not limited to, an amount of fat of about 8%, about 12%, and about 16%.

Moisture may be added to the disclosed batters. Sources of moisture include added water or water-containing ingredients such as eggs, buttermilk, milk, and the like. As noted above, a greater amount of moisture can be added to batters containing effective amounts of sodium alginate, a monoglyceride emulsifier, and gellan gum. The amount of moisture added from water or water-containing ingredients or both may range from about 20% to about 55%. This includes, but is not limited to, an amount of moisture of about 25%, about 30%, about 35%, about 40%, and about 45%.

The disclosed batters may further include other ingredients such as other emulsifiers, starches, nutritional enhancements, flavoring agents, coloring agents, inclusions/particulates, shelf life stabilizing ingredients, and combinations thereof.

Besides the monoglyceride emulsifier, other emulsifiers may be optionally added to the batters to increase volume and/or improve product texture and shelf-life. These other emulsifiers include, but are not limited to mono- and diglycerides, polysorbate 60, polysorbate 65, polysorbate 80, propylene glycol monoester, sodium stearoyl lactylate, sorbitan monostearate, diacetyl tartaric ester of monoglyceride, distilled monoglycerides, lecithin, and combinations thereof. These emulsifiers may be added up to about 1%, 2%, 3%, 4%, or even 5%.

Starches may be added to the product to alter the viscosity of the raw batter or to adjust the volume and texture of the baked good. Non-limiting examples of starches include corn starch, waxy maize, wheat starch, potato starch, barley starch, rice starch, tapioca starch, oat starch, sago starch, and combinations thereof. The starch can also be modified or pregelatinized. If present, starches are included in an amount ranging from about 0.5% to about 3%. This includes, but is not limited to amounts of about 1%, about 1.5%, about 2%, and about 2.5%.

Nutritional enhancing ingredients that may be added include vitamins, minerals, fibers, whole grains, proteins, and combinations thereof.

Flavoring agents that may be added include salt, spices, seasonings, artificial high intensity sweeteners such as sucralose, flavors, cocoa, cheese powders, ground vegetable powders, and combinations thereof.

Inclusions/particulates can also be added to the batter. Non-limiting examples include chocolate bits, flavored chips/bits, fruits, nuts, oats, butterscotch bits, maple bits, cinnamon bits, peanut butter chips, vegetables, and combinations thereof.

Shelf life stabilizing ingredients can also be optionally added to the batter. Such ingredients include, but are not limited to antioxidants, pH regulators, chelating agents, antimicrobial agents, and the like. Non-limiting examples of antioxidants include butylated hydroxyl anisole, butylated hydroxyl toluene, tertiary butyl hydroquinine, and the like. Non-limiting examples of pH regulators include citric acid, calcium acetate, sorbic acid, and the like. A non-limiting example of a chelating agent is ethylene diaminetetraacetate (EDTA), and the like. Non-limiting examples of antimicrobial agents include potassium sorbate, sorbic acid and its derivatives, propionic acid and its derivatives, sodium diacetate, vinegar, monocalcium phosphate, lactic acid, citric acid, and the like.

The batters disclosed herein may be used to form a variety of baked goods. Non-limiting examples of baked goods include cakes, pound cakes, coffee cakes, muffins, donuts, cupcakes, pancakes, muffin tops, brownies, biscuits, cinnamon rolls, Danish, puff pastry, waffles, and scones. In some embodiments, the baked good is a cake. In such embodiments, the cake may consist of a single cake layer, two cake layers, three cake layers or more.

Also provided are methods of making baked goods from the disclosed batters. In a basic embodiment, the method may include forming any of the batters disclosed herein by combining the appropriate ingredients, and baking the batter to provide the baked good. Prior to baking the batter, the batter may be deposited in a baking receptacle (e.g., a baking pan). The shape and size of the baking pan, as well as the amount of batter deposited in the baking pan, is not critical and depends upon the desired shape, size, and type of the baked good.

The batter may be baked in a variety ovens, using a variety of baking temperatures and baking times. By way of example only, a 36 deck reel oven may be used with an upper burner temperature of about 250° F. and a lower burner temperature of about 280° F. A direct fire oven may also be used having five zones set to 300° F., 320° F., 340° F., 350° F., and respectively. An impingement oven having five zones, each set to 350° F. may also be used. Other temperatures for each of these oven types may be used. The baking time may vary and depends upon the size and type of the baked good. By way of example only, when the baked good is a cake, the baking time may range from about 15 minutes to about 45 minutes. This includes baking times of about 20 minutes, 30 minutes, and 40 minutes. It should be understood that the baking method is not limited to oven baking. Griddles, stove stops, microwaves, and other similar equipment may also be used to bake the disclosed batters.

After baking, the methods may include a variety of other steps. By way of example only, the baked goods may undergo one or more cooling steps, a depannirng step, one or more assembly steps, and one or more freezing steps. Assembly steps may include stacking layers of baked goods, e.g., for a cake, icing or frosting the baked good, or other similar steps. The number of steps and the sequence of the steps may vary. In one embodiment in which the baked good is a cake, the cake may undergo a first cooling step, a depanning step, a first assembly step comprising stacking the layers of the cake, a second cooling step, a freezing step, and a second assembly step comprising icing the cake layers. In another similar embodiment, the cake may undergo a first cooling step, a depanning step, an assembly step comprising stacking the layers of the cake and icing the cake layers, and a freezing step. In yet another embodiment, the cake may undergo a first cooling step, a depanning step, a first freezing step, an assembly step comprising stacking the layers of the cake and icing the cake layers, and a second freezing step.

The baked goods may be cooled by a variety of different methods. By way of example only, the baked goods may be cooled at ambient temperature. The cooling time may vary, including 1 minute, 5 minutes, 10 minutes, 30 minutes, 1 hour, 2 hours, or even more. Alternatively, the baked goods may be cooled in a spiral cooler. The settings for the spiral cooler may vary. In some embodiments, the temperature of the spiral cooler is about 30° F., 35° F., 40° F., or about 45° F. However, other temperatures may be used. Again, the cooling time may vary, including 5 minutes, 10 minutes, 20 minutes, 30 minutes, or even more.

Similarly, the baked goods may be frozen by a variety of different methods. By way of example only, the baked goods may be frozen in a conventional freezer. The freezing time may vary, including 1 hours, 5 hours, 10 hours, or even more. Alternatively, the baked goods may be frozen in a spiral freezer. The settings for the spiral freezer may vary. In some embodiments, the temperature of the spiral freezer is about 0° F., −10° F., −20° F., or even less. However, other temperatures may be used. Again, the freezing time may vary, including 20 minutes, 30 minutes, 40 minutes, 50 minutes, 1 hour, or even more.

One skilled in the art will readily realize that all ranges and ratios discussed can and do necessarily also describe all subranges and subratios therein for all purposes and that all such subranges and subratios also form part and parcel of this invention. Any listed range or ratio can be easily recognized as sufficiently describing and enabling the same range or ratio being broken down into at least equal halves, thirds, quarters, fifths, tenths, etc. As a non-limiting example, each range or ratio discussed herein can be readily broken down into a lower third, middle third and upper third, etc.

For the purposes of this disclosure and unless otherwise specified, “a” or “an” means “one or more.” All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

### EXAMPLES

### Example 1

### Batter Formulation

Table 1 lists the ingredients for an exemplary batter for making a yellow (golden) cake.

TABLE 1
Exemplary batter formulation for a yellow (golden) cake.

| Ingredient | Percentage (wt %) |
|---|---|
| Flour | 22.73 |
| Sugar | 23.09 |
| Water | 21.67 |
| Eggs | 14.85 |
| Oil | 7.96 |
| Corn Syrup | 3.25 |
| Milk Protein | 1.54 |
| Double Acting Baking Powder | 1.22 |
| Starch | 1.10 |
| Emulsifier | 0.61 |
| Color and Flavors | 0.61 |
| Monoglyceride | 0.41 |
| Salt | 0.37 |
| Lactose | 0.32 |
| Sodium Alginate | 0.24 |
| Gellan Gum | 0.04 |

### Example 2

### Retained Moisture of Various Baked Goods

In this example, three “test” cakes were analyzed for retained moisture content. Each of the test cakes were formed from batters comprising sodium alginate, a monoglyceride emulsifier, and gellan gum. The batter formulation for the yellow test cake is provided in Example 1. The test cakes were made according to the methods described above. The retained moisture content of the test cakes was determined using the modified AOAC Official Method 934.06 Moisture in Dried Fruits, as described above.

The test cakes were each compared to a control cake and/or a comparative, commercially available cake. The control cakes were formed from batters which did not include either sodium alginate, a monoglyceride emulsifier, or gellan gum. Otherwise, the batter formulations and methods for making the control cakes were comparable to the test cakes. The comparative cakes were purchased commercially. Both the control and commercially available cakes were tested for retained moisture content as described above.

The results of these comparative examples are shown in Table 2. Clearly, the retained moisture content of each of the test cakes was significantly greater than the retained moisture content of the control or commercially available cakes.

TABLE 2
Results of Retained Moisture Content Analysis.

| | % Moisture |
|---|---|
| Control Yellow Cake | 30 |
| Test Yellow Cake | 31.83 |
| Commercially Available Yellow Cake | 22.75 |
| Control German Chocolate Cake | 24.31 |
| Test German Chocolate Cake | 31.07 |
| Test Red Velvet Cake | 35.7 |
| Commercially Available Red Velvet Cake | 31.13 |

### Example 3

### Sensory Reports for Test Cakes and Control Cakes

In this example, three “test” cakes, a Chocolate Chocolate Torte, a Carrot Cake, and a Chocolate Butter Cream Layer Cake, and their corresponding “control” cakes were subjected to a taste test. The results were compiled into a Sensory Report. Each of the test cakes were formed from batters comprising sodium alginate, a monoglyceride emulsifier., and gellan gum. The control cakes did not include either sodium alginate, a monoglyceride emulsifier, or gellan gum. The test and control cakes were made according to the methods described above.

Each taste test involved either 60 or 66 subjects. These subjects had been pre-screened for liking the particular cake that was the subject of the taste test. Subjects received one slice ( 1/14) each of a test and control cake, served at room temperature. The test and control cakes were blind coded and were rotated in each serving position throughout the test. The subjects were asked to rate their overall liking, appearance liking, flavor liking, overall frosting liking, overall cake liking, texture liking, overall moistness liking, and aftertaste liking of the test and control cakes on a 9 Point Hedonic Scale. The 9 Point Hedonic Scale, which was developed by Peryam et al. in 1960 is a standardized scale widely used in sensory research. Each subject received the following scale with the terms described below.
9=Like Extremely
8=Like Very Much
7=Like Moderately
6=Like Slightly
5=Neither Like Nor Dislike
4=Dislike Slightly
3=Dislike Moderately
2=Dislike Very Much
1=Dislike Extremely
   For the analysis, terms were converted into the corresponding numeric values. All individual scores were then averaged to determine mean scores for each variable based on the hedonic question given. Statistical analysis ANOVA was used to determine differences between cake formulations. The results for the Chocolate Chocolate Torte and the Chocolate Butter Cream Layer Cake are shown in Tables 3 and 4 below.

TABLE 3
Sensory Report for Chocolate Chocolate Torte

| Mean Scores | | | |
|---|---|---|---|
| 9-Point Hedonic | | Control | |
| N = 66 | p-value | Formula | Test Formula |
| Overall Liking | 0.0006 | 6.8 b | 7.7 a |
| Appearance Liking | 0.0019 | 7.4 b | 8.0 a |
| Flavor Liking | 0.0027 | 6.7 b | 7.5 a |
| Overall Frosting Liking | 0.0050 | 6.7 b | 7.5 a |
| Overall Cake Liking | 0.0000 | 6.2 b | 7.4 a |
| Texture Liking | 0.0000 | 6.1 b | 7.4 a |
| Overall Moistness Liking | 0.0000 | 5.7 b | 7.3 a |
| Aftertaste Liking | 0.0304 | 6.7 b | 7.3 a |

Mean scores with different letters are significant at 95% confidence. Letters that are the same are not significantly different.

TABLE 4
Sensory Report for Chocolate Butter Cream Layer Cake

| Mean Scores | | | |
|---|---|---|---|
| 9-Point Hedonic | | Control | |
| N = 60 | p-value | Formula | Test Formula |
| Overall Liking | 0.0000 | 6.4 b | 7.4 a |
| Appearance Liking whole slice | 0.0054 | 7.1 b | 7.6 a |
| Exterior Frosting Appearance Liking | 0.7419 | 7.3 a | 7.4 a |
| Cake Layers Appearance Liking | 0.0007 | 6.8 b | 7.5 a |
| Flavor liking of the whole slice | 0.0000 | 6.5 b | 7.4 a |
| Overall Texture Liking whole slice | 0.0006 | 6.2 b | 7.2 a |
| Overall Moistness Liking whole slice | 0.0000 | 5.5 b | 6.8 a |
| Aftertaste Liking | 0.0009 | 6.5 b | 7.2 a |

Mean scores with different letters are significant at 95% confidence. Letters that are the same are not significantly different.

Similar results were obtained for the Test Carrot Cake. In all cases, the subjects rated their overall moistness liking of the test cakes significantly higher than their overall moistness liking of the control cakes. Thus, the perceived, as well as the measured, moisture content of the test cakes is quite high. As noted above, the increased retained moisture content of the disclosed cakes can also improve the texture of the cakes. Notably, the subjects rated their appearance liking, flavor liking, and texture liking of the test cakes significantly higher than their respective likings of the control cakes.

It should be understood that changes and modifications to the embodiments described herein can be made in accordance with ordinary skill in the art without departing from the invention in its broader aspects as defined in the following claims.

What is claimed is:

1. A batter comprising:
sodium alginate;
a monoglyceride emulsifier; and
gellan gum;
wherein the sodium alginate, the monoglyceride emulsifier, and the gellan gum are present in an amount effective to provide a baked good formed from the batter having a retained moisture content ranging from about 25% to about 40%.

2. The batter of claim 1, wherein the retained moisture content ranges from about 30% to about 40%.

3. The batter of claim 1, wherein the amount of sodium alginate ranges from about 0.1% to about 4%.

4. The batter of claim 1, wherein the amount of sodium alginate ranges from about 0.1% to about 1%.

5. The batter of claim 1, wherein the amount of the monoglyceride emulsifier ranges from about 0.1% to about 6%.

6. The batter of claim 1, wherein the amount of the monoglyceride emulsifier ranges from about 0.1% to about 2%.

7. The batter of claim 1, wherein the amount of gellan gum ranges from about 0.01% to about 5%.

8. The batter of claim 1, wherein the amount of gellan gum ranges from about 0.05% to about 2%.

9. The batter of claim 1, wherein the batter does not comprise xanthan gum.

10. The batter of claim 1, wherein the baked good is a cake.

11. The batter of claim 1, further comprising flour, a leavening system, fat, a protein supplement, a humectant, a starch, or a combination of any two or more thereof.

12. A batter comprising:
about 0.1% to about 4% sodium alginate;
about 0.1% to about 6% of a monoglyceride emulsifier; and
about 0.01% to about 5% of gellan gum;
wherein the sodium alginate, the monoglyceride emulsifier, and the gellan gum are present in an amount effective to provide a baked good formed from the batter having a retained moisture content ranging from about 25% to about 40%.

13. The batter of claim 12, wherein the amount of sodium alginate ranges from about 0.1% to about 1%, the amount of monoglyceride emulsifier ranges from about 0.1% to about 2%, and the amount of gellan gum ranges from about 0.05% to about 2%.

14. The batter of claim 12, wherein the baked good is a cake.

15. A method of making a baked good comprising:
forming a batter comprising
sodium alginate;
a monoglyceride emulsifier; and
gellan gum;
wherein the sodium alginate, the monoglyceride emulsifier, and the gellan gum are present in an amount effective to provide a baked good formed from the batter having a moisture content ranging from about 25% to about 40%; and
baking the batter to provide the baked good.

16. The method of claim 15, wherein the retained moisture content ranges from about 30% to about 40%.

17. The method of claim 15, wherein the amount of sodium alginate ranges from about 0.1% to about 4%, the amount of monoglyceride emulsifier ranges from about 0.1% to about 6%, and the amount of gellan gum ranges from about 0.01% to about 5%.

18. The method of claim 15, wherein the method further comprises one or more of cooling the baked good, depanning the baked good, assembling the baked good, and freezing the baked good.

19. A baked good prepared by the method of claim 15.

20. The baked good of claim 19, wherein the baked good is a cake.
